(19) United States
(12) Patent Application Publication
(10) Pub. No.: US 2013/0189409 A1
(43) Pub. Date: Jul. 25, 2013

(54) SYSTEMS AND METHODS FOR MAINTAINING PERISHABLE FOODS

(71) Applicant: Laurence D. Bell, Mountain View, CA (US)

(72) Inventor: Laurence D. Bell, Mountain View, CA (US)

(73) Assignee: Global Fresh Foods

(21) Appl. No.: 13/601,872

(22) Filed: Aug. 31, 2012

Related U.S. Application Data
(60) Provisional application No. 61/590,756, filed on Jan. 25, 2012.
(60) Provisional application No. 61/607,258, filed on Mar. 6, 2012.
(60) Provisional application No. 61/646,076, filed on May 11, 2012.

(51) Int. Cl. A23B 4/16; A23L 1/325; A23L 1/314

(52) U.S. Cl. 426/263; 426/647; 426/643

(57) ABSTRACT

Disclosed are methods for stabilizing an oxygen dependent or oxygen-labile pigment from discoloration, and for maintaining the freshness and preventing discoloration of a foodstuff comprising the oxygen-labile pigment. In some embodiments, the method comprises (1) reducing the oxygen concentration in the atmosphere of a sealed container comprising the pigment to a level such that the oxygen will not discolor the pigment when CO₂ is introduced into the container, and (2) introducing CO₂ into the sealed container while retaining or further reducing the oxygen concentration in the atmosphere of the sealed container. Systems useful in the methods disclosed herein.

### CROSS-REFERENCE TO RELATED APPLICATIONS

This application claims the benefit under 35 U.S.C. §119 of U.S. Provisional Patent Application Ser. No. 61/590,756, filed on Jan. 25, 2012, U.S. Provisional Patent Application Ser. No. 61/607,258, filed on Mar. 6, 2012, and U.S. Provisional Patent Application Ser. No. 61/646,076, filed on May 11, 2012, each of which is incorporated herein by reference in its entirety.

### TECHNICAL FIELD

This invention relates to systems and methods for stabilizing oxygen-dependent and oxygen-labile pigments during storage. In particular, many foodstuffs such as muscle foods (red meat, fish, etc.) have oxygen-labile pigments which contribute to their general fresh appearance. Such foodstuffs are typically stored in a gaseous atmosphere containing elevated carbon dioxide levels so as to inhibit spoilage of these foodstuffs while preserving their apparent freshness.

### BACKGROUND

The storage-life of oxidatively-degradable foodstuffs such as fish, meat, and poultry is limited in the presence of a normal atmospheric environment. The presence of oxygen at levels found in a normal atmospheric environment leads to changes in odor, flavor, color, and texture resulting in an overall deterioration in quality of the foods either by chemical effect or by growth of aerobic spoilage microorganisms.

Modified atmosphere packaging (MAP) has been used to improve storage-life and safety of stored foods by inhibition of spoilage microorganisms and pathogens. MAP is the replacement of some or most of the normal atmospheric environment in a food storage pack with a single inert gas or a mixture of inert gases. The resulting gas in a MAP mixture is most often combinations of nitrogen (N₂) and carbon dioxide (CO₂) with a small amount of oxygen (O₂). In most cases, the bacteriostatic effect is obtained by a combination of decreased O₂ and increased CO₂ concentrations. Farber, J. M. 1991. Microbiological aspects of modified-atmosphere packaging technology: a review. J. Food Protect. 54:58-70.

U.S. Pat. No. 8,187,653 and US Patent Application Publication Nos. 2011/0151070 and 2011/0151084, and International Application WO2011/053676 provide methods and systems of preserving oxidatively-degradable foodstuffs in containers, such as totes, having an atmosphere that is low in O₂, and in some embodiments, high in CO₂. These methods and systems have demonstrated uniquely extended shelf life after removal from the “Controlled” atmosphere compared to conventional MAP and Vacuum packaging technologies. These publications are incorporated by reference in their entirety.

Notwithstanding the benefits imparted by these methods and systems, foodstuffs and other pigment containing materials can undergo discoloration in such a manner that the food is perceived by the consumer as not fresh. For example, myoglobin is an iron- and oxygen-binding protein that provides the desirable red color of most meats when the myoglobin protein in the muscle is fully oxygenated.

The color of consumable red meat will change to an unappealing darkish brown when left in air for too long a period of time. This is caused by denaturation of the myoglobin protein by spoilage organisms, desiccation and other deteriorative processes that render the myoglobin incapable of sufficiently reacting with oxygen to provide the desirable bright red pigment.

### SUMMARY

This invention is predicated in part on the discovery that heretofore used deoxygenation processes which introduce carbon dioxide into the modified atmosphere do not adequately prevent the deterioration of myoglobin and may in fact facilitate it. This invention is further predicated in part on the discovery of deoxygenation methods that provide for a carbon dioxide rich modified atmosphere while preserving the color of foodstuffs comprising myoglobin. Without being limited to any theory, it is believed that current MAP procedures employing an initial CO₂ flush with no deoxygenation pretreatment to maintain freshness of foodstuffs contribute to or at least do not alter the irreversible damage to the myoglobin pigments. In particular, it is believed that as CO₂ is introduced into a sealed container, the pigment structure and chemistry is altered in a manner that prevents the pigment from fully reoxygenating upon return to ambient air. Regardless of its mechanism, discoloration results in an “aged” appearance in the foodstuff that reduces their commercial value.

In one aspect, provided herein is a method to stabilize foodstuffs comprising an oxygen-dependent and/or oxygen-labile pigment from losing the ability to fully reoxygenate after storage in a sealed container comprising a carbon dioxide enriched atmosphere, which method comprises

(1) reducing the oxygen concentration in the atmosphere of the container without introducing exogenous carbon dioxide wherein the oxygen concentration is reduced to a level such that pigment damage is minimized over the period of time when exogenous CO₂ is introduced into the container, and

(2) introducing exogenous CO₂ into the container while retaining or further reducing the oxygen concentration in the atmosphere of the container.

In another aspect, provided herein is a method to stabilize myoglobin pigment of a foodstuff containing myoglobin pigment during transportation and/or storage of the foodstuff in a sealed container to maintain the freshness and prevent discoloration of the foodstuff when returned to air, which method comprises

(1) replacing at least a portion of the atmosphere in the container with a nitrogen flush so as to reduce the oxygen concentration to less than 5%, and incubate the foodstuff in the container for a period sufficient to deoxygenate the foodstuff, and

(2) replacing at least a portion of the atmosphere of the container with a sufficient amount of exogenous carbon dioxide to prevent spoilage and account for absorption of carbon dioxide by the foodstuff, thereby maintaining the freshness, and preventing discoloration of the foodstuff upon return to ambient air after a period of at least 3 days in the predominantly CO₂ modified atmosphere environment.

In some embodiments of the foregoing aspects, the pigment is myoglobin.

In some embodiments, the oxygen concentration of step (2) is maintained in the sealed container at least three days.

In some embodiments, the oxygen concentration is reduced by a fuel cell. In some embodiments, the fuel cell is internal to the container. In some embodiments, the fuel cell is external to the container.

In some embodiments, the oxygen concentration is reduced by replacing the oxygen with an inert gas. In some embodiments, the inert gas is nitrogen.

In some embodiments, the oxygen concentration in the atmosphere of the sealed container is reduced to less than 5%.

In some embodiments of the foregoing aspects, before step (2), the foodstuff is incubated in the atmosphere produced in step (1) so as to allow a portion of the oxygen within the foodstuff to enter the atmosphere in the container. In some embodiments, before step (2), the foodstuff is incubated in the atmosphere of the container produced in step (1) for at least 1 hour. In some embodiments, in step (2), the oxygen concentration in the atmosphere of the sealed container is further reduced to less than 1500 ppm.

In some embodiments, the sealed container is a tote comprising a flexible, collapsible or expandable material. In some embodiments, the tote comprises a headspace. In some embodiments, the sealed container is rigid container.

In some embodiments, the pigment is myoglobin pigment present in red meat. In some embodiments, the pigment is myoglobin pigment present in tilapia, tuna, or mackerel.

In some embodiments, the predictable period of time is at least 3 days.

In another aspect, provided herein are containers, systems and devices useful in the methods.

In another aspect, provided herein is a stabilized foodstuff comprising an oxygen-dependent pigment, wherein said foodstuff is maintained in a sealed container comprising an atmosphere comprising carbon dioxide and no more than about 1% oxygen.

These and other aspects of the invention is further described in the text that follows.

### BRIEF DESCRIPTION OF THE DRAWINGS

This invention will be further described with reference being made to the accompanying drawings.

FIG. 1 is a schematic illustration of a container 1 used to transport or store a foodstuff 2 comprising an oxygen-dependent or oxygen-labile pigment wherein the container is connected to an external oxygen remover 6 which removes oxygen from the atmosphere 3 of the container through outlet 4 and inlet 5.

FIG. 2 is a schematic illustration of a container 1 used to transport or store a foodstuff 2 comprising an oxygen-dependent or oxygen-labile pigment wherein the container is connected to an internal oxygen remover 6′ which removes oxygen from the atmosphere 3 of the container.

FIG. 3 is a schematic illustration of a container 1 used to transport or store a foodstuff 2 comprising an oxygen-dependent or oxygen-labile pigment wherein the container is connected to more than one external oxygen removers 7, 8 and 9 which remove oxygen from the atmosphere 3 of the container, and wherein the oxygen removers are in a parallel configuration. The three oxygen removers are for illustration purposes only. The number of oxygen removers can be one, two or more.

FIG. 4 is a schematic illustration of a container 1 used to transport or store a foodstuff 2 comprising an oxygen-dependent or oxygen-labile pigment wherein the container is connected to more than one external oxygen removers 7, 8 and 9 which remove oxygen from the atmosphere 3 of the container, and wherein the oxygen removers are in a sequential configuration. The three oxygen removers are for illustration purposes only. The number of oxygen removers can be one, two or more.

FIG. 5 is a schematic illustration of a container 1 used to transport or store a foodstuff 2 comprising an oxygen-dependent or oxygen-labile pigment wherein the container is connected to one or more external oxygen removers which remove oxygen from the atmosphere 3 of the container and wherein at least a portion of the gas is released before treatment with the oxygen removers. The container further comprises a sensor 10, which comprises an oxygen sensor and/or a temperature sensor.

FIG. 6 is a schematic illustration of a container 1 used to transport or store a foodstuff 2 comprising an oxygen-dependent or oxygen-labile pigment wherein the container is connected to external oxygen removers which remove oxygen from the atmosphere 3 of the container and wherein at least a portion of the gas is released after treatment with the oxygen removers. The container further comprises a sensor 10, which comprises an oxygen sensor and/or a temperature sensor.

### DETAILED DESCRIPTION

### Definitions

It is to be noted that as used herein and in the claims, the singular forms “a,” “an” and “the” include plural referents unless the context clearly dictates otherwise. Thus, for example, reference to “a fuel cell” includes one, two or more fuel cells, and so forth.

The term “comprising” is intended to mean that the articles and methods include the recited elements, but do not exclude others. “Consisting essentially of” when used to define articles and methods, shall mean excluding other elements of any essential significance to the intended use. “Consisting of” shall mean excluding more than trace amounts of other elements and substantial method steps.

The term “about” when used before a numerical designation, e.g., temperature, time, amount, and concentration, including range, indicates approximations which may vary by (+) or (−) 15%, 10%, 5% or 1%.

The term “oxygen-labile pigment” refers to naturally occurring pigments which are susceptible to discoloration upon storage in the presence of oxygen or an oxidative condition. Examples of such pigments include carmine, beta carotene, carotenoids and paprika.

The term “oxygen-dependent pigment” refers to naturally occurring pigments which are dependent on oxygen to express fresh color. Examples of such pigments include myoglobin and hemoglobin.

Myoglobin is an iron- and oxygen-binding protein found in animal muscle tissues, and provides a bright red color to a foodstuff or a portion of the foodstuff which comprises myoglobin, such as red meat and tilapia. Its color depends on the state of the iron atom present in the myoglobin molecule. When the iron atom is present as Fe²⁺ and associated with an oxygen molecule, the myoglobin, which is referred to as oxymyoglobin (O₂Mb), shows the bright red color that consumers associate with fresh meat. When the iron atom is present as Fe²⁺ and associated with a water molecule, the myoglobin, which is referred to as myoglobin (Mb), shows a purple color, and when the iron atom is present as Fe³⁺ and associated with a water molecule, the myoglobin, which is referred to as metmyoglobin (MetMb), shows a brown color. Both O₂Mb and Mb are referred to as reduced forms of myoglobin. Meat products having either a purple or a brown color are not appealing to the consumers. The three states of myoglobin, and thus the colors, are reversible if MetMb can be reduced to Mb. In fresh meat, MetMb is reduced to Mb by enzymes. Mb is oxygenated to O₂Mb to give the bright red color when the oxygen concentration is high. When oxygen concentration is low, O₂Mb is deoxygenated to Mb. Both O₂Mb and Mb can be oxidized to MetMb. A meat product will irreversibly lose its bright red color if the meat loses its ability to reduce MetMb to Mb.

The term “red meat” as used herein refers to a meat or fish product comprising more than about 0.05% myoglobin pigment. Examples of red meat include beef, pork, lamb, dark-colored chicken, fish, such as tuna and tilapia, and other sea foods.

The term “discoloration” refers to an irreversible loss of the color of a pigment that indicates the apparent freshness of a foodstuff comprising the pigment. For example, the bright red color of myoglobin pigment is an indication to many consumers that a red meat is fresh. A red meat product that partially or completely loses the bright red color, for example, by turning to a brownish color, is often perceived by consumers as loss of freshness. Thus, an irreversible loss of the bright red color of the myoglobin pigment is referred to as discoloration.

The term “freshness” refers to a state of a foodstuff that displays characteristics, such as a color, texture and smell, as if it is just produced.

The term “inert gas” refers to a gas that is non-toxic and does not react with the foodstuff Examples of inert gas include nitrogen, argon, krypton, helium, nitric oxide, nitrous oxide, and xenon.

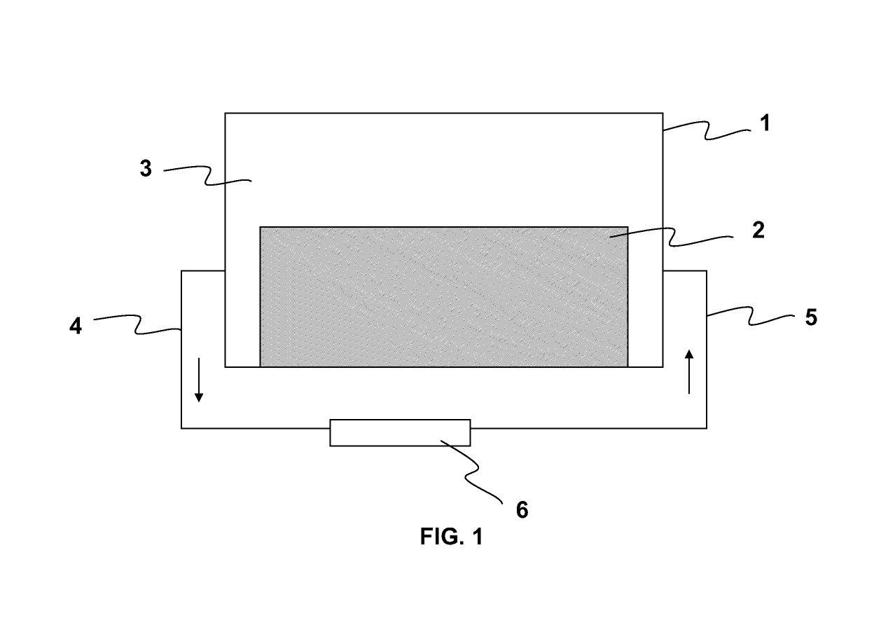

The term “sealed container” refers to a container whose interior is isolated from ambient atmosphere without uncontrolled introduction and/or emission of gas, except gas that may diffuse into and/or out of the container through its wall material. A sealed container may comprise inlets and/or outlets which, when opened, allow controlled introduction and/or emission of gas to or from the container. Thus, a container is considered sealed for the purpose of this invention, if the architecture of the container controls the gas content within the container. In one embodiment, the architecture employs only the gas inside the container without the introduction of any further exogenous gases. That is to say that once flushing is completed, the atmosphere content is in a closed system such as depicted in FIGS. 1-4. The sealed container also encompasses architecture where gas can be introduced or released under controlled conditions. In some situations, the architecture only permits additional gas intake. This is particularly important in situations where the foodstuff absorbs gas, such as carbon dioxide. The intake of additional gas allows controlled gas intake into the headspace of the container. In another embodiment, the architecture permits both releasing a portion of the gas outside the container and introducing a different gas into the container. Such a system permits a more rapid deoxygenating process. Regardless, the container is considered sealed as the gaseous contents in the container are controlled and are independent of the atmosphere. Simply put, a sealed container is a container designed to prevent ambient atmospheric gas from entering into the container except by diffusion through the container (e.g. diffusion through a flexible plastic sheet). “Ambient atmosphere gas” or “ambient air” refers to gas in the general atmosphere typically comprising about 78% of nitrogen and about 21% of oxygen.

The term “deoxygenation of a foodstuff” or “deoxygenate of a foodstuff” refers to reduction of the oxygen contained in and around the foodstuff.

The term “carbon dioxide enriched atmosphere” refers to an atmosphere in a confined space, such as a sealed container, that comprises carbon dioxide in an amount higher than that in the ambient atmosphere, and optionally comprises an inert gas or a mixture of inert gases, and substantially free of oxygen. In some embodiments, the concentration of carbon dioxide is at least about 40 vol. % or at least about 60 vol. %. In some embodiments, the carbon dioxide atmosphere contains about 60 vol. % carbon dioxide and about 40 vol. % nitrogen. In some embodiments, the carbon dioxide atmosphere comprises at least 90 vol. % carbon dioxide. The term “substantially free” when used to refer to an amount of oxygen or carbon dioxide refers to an amount that does not interfere with preservation of the red meat and the color of red meat, for example, an amount that is no more than about 5 vol. %, 1 vol. %, about 0.1 vol. %, or about 0.01 vol. %. In some embodiments, substantially free of oxygen means that the oxygen concentration in the atmosphere is no more than 100, or 10 ppm.

### Methods

The color of a foodstuff is an important factor in whether the consumers accept or reject the product. For example, consumers usually associate the loss of the bright red color of red meat, known as loss of “bloom” in the food industry, with loss of freshness and bacterial growth. Therefore, it is important to preserve the color of a foodstuff. In one aspect, provided herein are methods useful for stabilizing an oxygen-dependent or oxygen-labile pigment from discoloration, and transporting and storing foodstuffs comprising the pigment for an extended period of time.

In one aspect, provided herein is a method to stabilize foodstuffs comprising an oxygen-dependent or oxygen-labile pigment from losing the ability to fully reoxygenate after storage in a sealed container comprising a carbon dioxide enriched atmosphere, which method comprises.

(1) reducing the oxygen concentration in the atmosphere of the container without introducing exogenous carbon dioxide wherein the oxygen concentration is reduced to a level such that pigment damage or oxidation and resulting discoloration does not occur over the predictable period of time when exogenous CO₂ is introduced into the container, and

(2) introducing exogenous CO₂ into the container while retaining or further reducing the oxygen concentration in the atmosphere of the container.

In one aspect, provided herein is a method to stabilize an oxygen dependent or oxygen-labile pigment from discoloration for a predictable period of time in a sealed container, which method comprises

(1) reducing the oxygen concentration in the atmosphere of the sealed container to a level such that the oxygen will not destabilize the myoglobin molecule when CO₂ is introduced into the container, and

(2) introducing CO₂ into the container in an amount sufficient to account to any absorption of CO₂ while retaining or further reducing the oxygen concentration in the atmosphere of the sealed container.

In another aspect, provided herein is a method to stabilize myoglobin pigment of a foodstuff containing myoglobin pigment during transportation and/or storage of the foodstuff in a sealed container to maintain the freshness and prevent discoloration of the foodstuff, which method comprises

(1) reducing the oxygen concentration of the atmosphere of the container to less than 5%,

(2) and replacing at least a portion of the atmosphere of the container with a sufficient amount of exogenous carbon dioxide to prevent spoilage and account for absorption of carbon dioxide by the foodstuff, thereby maintaining the freshness, and preventing discoloration of the foodstuff upon return to ambient air after a period of at least 3 days in the predominantly CO₂, modified atmosphere environment.

In some embodiments, reduction of oxygen concentration is achieved without reducing of the internal gaseous pressure of the container by more than 50%. In some embodiments, reduction of oxygen concentration is achieved without reducing the internal gaseous pressure by more than 25%. In some embodiments, reduction of oxygen concentration is achieved without reducing the internal gaseous pressure by more than 5%. In some embodiments, reduction of oxygen concentration is achieved without reducing the internal gaseous pressure. This avoids excessive pressure differentiation between inside and outside of the container.

In some embodiments of the methods disclosed herein, in step (1), the oxygen concentration in the atmosphere of the container is reduced by operation of an oxygen removers, such as a fuel cell, which removes oxygen and are in gaseous communication with the container. One or more fuel cells may be contained internal or external to the container. In some embodiments, the fuel cells convert hydrogen and oxygen into water. The container further optionally comprises a hydrogen source internal or external to the container. The container further optionally comprises a holding element suitable for maintaining a hydrogen source internal or external to the container. The holding element for the hydrogen source in the container preferably is a box or bladder configured to hold the hydrogen source and, in some embodiments, the fuel cell. In some embodiments, the hydrogen source is one or more cylinders comprising compressed hydrogen.

In some embodiments of the methods disclosed herein, in step (1), the oxygen concentration in the atmosphere of the container is reduced by replacing the oxygen with an inert gas. In some embodiments, the inert gas comprises argon, helium, and/or nitrogen, and comprises no more than 1% of carbon dioxide. In some embodiments, the inert gas comprises no carbon dioxide. In some embodiments, the inert gas is selected from the group consisting of nitrogen, helium and argon. In some embodiments, the inert gas is nitrogen.

In some embodiments, the container comprises plumbing valves and fittings for use to flush the container with the inert gas to replace the oxygen in step (1) and/or to flush the container with carbon dioxide to replace the inert gas in step (2). The inert gas or carbon dioxide used to flush the container is introduced from an inlet, the gas in the container that is replaced by the inert gas or carbon dioxide flush is released through an outlet. After the flush, the inlet and outlet are closed to maintain the atmosphere obtained by the flush.

Gas flush and oxygen remover, such as fuel cell, operation can be done independently or in combination. In some embodiments, the container is flushed prior to turning on the oxygen remover, such as fuel cell. In some embodiments, the container is flushed while the oxygen remover, such as fuel cell is in operation to remove oxygen. The oxygen remover, such as fuel cell, may continue to remove oxygen during the transportation and/or storage. In some embodiments, the oxygen remover independently removes oxygen with no introduction of gas until deoxygenation is accomplished.

In some embodiments, provided herein is a method to stabilize myoglobin pigment of a foodstuff comprising myoglobin pigment during transportation and/or storage of the foodstuff in a sealed container to maintain the freshness and prevent discoloration of the foodstuff, which method comprises

(1) reducing the oxygen concentration of the atmosphere of the sealed container to less than 5%, and incubate the foodstuff in the container for a period sufficient to reach deoxygenation of the foodstuff, and

(2) replacing at least a portion of the atmosphere of the sealed container with a sufficient amount of carbon dioxide so as to maintain the freshness and prevent discoloration of the foodstuff for a period of at least 3 days.

In some embodiments, provided herein is a method to stabilize myoglobin pigment of a foodstuff comprising myoglobin pigment during transportation and/or storage of the foodstuff in a sealed container to maintain the freshness and prevent discoloration of the foodstuff, which method comprises

(1) replacing at least a portion of the atmosphere in the container with a nitrogen flush so as to reduce the oxygen concentration to less than 5%, and incubate the foodstuff in the sealed container for a period sufficient to reach deoxygenation, and

(2) replacing at least a portion of the atmosphere of the sealed container with a sufficient amount of carbon dioxide so as to maintain the freshness and prevent discoloration of the foodstuff upon return to ambient air after a period of at least 3 days in the atmosphere of the sealed container.

In some embodiments, the foodstuff is added to the container before step (1) of the methods disclosed herein. In some embodiments, the foodstuff is added to the container after the oxygen concentration is reduced or the portion of the atmosphere of the container is replaced with a nitrogen flush step (1) of the methods disclosed herein.

In some embodiments of the methods, in step (1), the oxygen concentration in the atmosphere of the sealed container is reduced to less than about 5%, 4%, 3%, 2% or 1%. In some embodiments, the oxygen concentration in the atmosphere of the sealed container is reduced to less than 0.1%. In some embodiments, the oxygen concentration in the atmosphere of the sealed container is reduced to less than 0.01%.

In some embodiments of the methods, the foodstuff is incubated in the atmosphere of step (1) for at least about 1 hour before step (2) when the portion of the atmosphere is replaced with carbon dioxide. In some embodiments, the foodstuff is incubated in the atmosphere of step (1) for at least 2 hours, 5 hours, 7 hours or at least 12 hours before step (2) when the portion of the atmosphere is replaced with carbon dioxide.

In some embodiments of the methods, in step (2), the oxygen concentration in the atmosphere of the sealed container is further reduced to less than 1500 ppm, by for example, replacing the oxygen with carbon dioxide and/or operation of the fuel cell.

In some embodiments of the methods, in step (2), at least about 60 vol. percent of the atmosphere in the container is replaced with carbon dioxide or a low oxygen gas comprising carbon dioxide. In some embodiments, the low oxygen gas is a mixture of CO₂ and nitrogen or other inert gas, for example, a mixture of 60% CO₂ and 40% nitrogen. In one embodiment, the carbon dioxide or the low oxygen gas contains less than 100, or 10 ppm oxygen. In some embodiments of the methods, in step (2), at least 90 vol. percent of the atmosphere in the container is replaced with carbon dioxide. In some embodiments, the atmosphere of the container comprises at least 60 vol. percent carbon dioxide after completion of step (2). In some embodiments, the atmosphere of the container comprises at least 90 vol. percent carbon dioxide after completion of step (2).

Preferably the gas used is acceptable by the relevant regulatory agencies, such as the U.S. Food and Drug Administration (FDA) “GRAS” (Generally Recognized as Safe) food grade carbon dioxide and nitrogen.

It should be understood that one source of oxygen in certain food stuffs is its release from hemoglobin. In such a case, carbon monoxide interacts with and binds more strongly to the hemoglobin than oxygen. Accordingly, for the purposes of this invention, carbon monoxide is considered not to be an inert gas.

In some embodiments of the methods, the container is a tote comprising a flexible, collapsible or expandable material with limited oxygen permeability which does not puncture when collapsing or expanding. The tote can withstand or volumetrically compensate for, the internal pressure loss such as carbon dioxide absorption by the foodstuff, or pressure gain, such as reduction of barometric pressure during transport and/or shipment.

In some embodiments, the tote comprises an initial headspace that compensates for such absorption permitting the oxygen concentration in the tote to be maintained at a desired level and/or without creating a vacuum condition. In some embodiments, the initial headspace occupies at least 30 or at least 40 volume percent of the tote. In some embodiments, the initial headspace occupies about 50 volume percent of the tote. In one embodiment, the headspace is about or at least 69 vol. percent of the tote. In some embodiments, the initial headspace is from about 30% to about 95% the internal volume of the tote. In other embodiments, the initial headspace is from about 35% to about 40% of the internal volume of the tote, or alternatively, the initial headspace is about 30% to about 35% of the internal volume of the tote, or alternatively, the initial headspace is about 35% of the internal volume of the tote.

In some embodiments, the vertical architecture of the tote facilitates minimizing horizontal space requirements for shipping the maximum number of pallets side-by-side. Embodiments that spread the headspace out horizontally may not be as economically viable at a large scale in addition to not enjoying the leak resistance as long as the headspace remains positive. In certain embodiments, no more than about 20% of the expansion of the tote is in the horizontal direction, with the remainder of the gaseous expansion being in the vertical direction thus creating the “head pressure” and head space height of the tote. The tote is configured to expand in a vertical manner creating an initial “head pressure” after the carbon dioxide flush. Initial tote head pressures can range from about 0.1 to about 1.0 inches of water column or more above atmospheric pressure. The flexible tote can be made more flexible in the vertical direction than in the horizontal by conventional methods, such as using more flexible material in the vertical direction.

In some embodiments, the totes are able to accommodate a sufficient headspace such that the tote would require no continuous oxygen monitoring and/further periodic gas flushing after the atmosphere of the tote is replaced with a sufficient amount of carbon dioxide in step (2). In some embodiment, the gas flushes with carbon dioxide in step (2) can proceed periodically for up to 72 hours, for example, 60 hours, or alternatively, 48 hours, or alternatively, 24 hours, after step (1). Alternatively, the initial gas flushes can proceed during the first 72 hours or less, or alternatively, the first 60 hours, or alternatively, the first 48 hours, or alternatively, the first 24 hours, after start of step (2).

In some embodiments, the container is a rigid room or container. When the container is a rigid room or container, after step (2), an inert gas, such as nitrogen, or carbon dioxide can be introduced continuously or intermittently as needed to the room or container to compensate for gas absorption by the foodstuff and keep the oxygen concentration at a desired low level until the foodstuff is released for distribution. Alternatively, an oxygen remover may be operated continuously or intermittently to keep the oxygen concentration at a desired low level.

In some embodiments of the methods, the foodstuff is red meat. In some embodiments, the foodstuff is beef, lamb or pork. In some embodiments, the foodstuff is fish comprising the myoglobin pigment or hemoglobin pigment. In some embodiments, the foodstuff is tilapia. In some embodiments, the foodstuff is tuna, mackerel and other seafoods.

The methods can be used in the transporting or storing the foodstuff for a time periods in excess of 100 days. In some embodiments of the methods, the transportation and/or storage is for a time period of at least 3 days. In some embodiments, the transportation and/or storage is for a time period of at least 5, 10, 15, 30, or 45 days.

Oxygen may accumulate in the container during transportation and/or storage by, for example, diffusion into the container through the material of limited oxygen permeability or at the seal of the container. Oxygen may also be released by the foodstuff within the container or from containers in which the foodstuff is packaged. In some embodiments, the oxygen concentration of the atmosphere of the containers is maintained at or below 1500 ppm during the transportation and/or storage by, for example, operation of the one or more fuel cells or additional flushes with a gas comprising an inert gas and/or carbon dioxide. The removal of oxygen can be performed continuous or periodically. If performed periodically, the removal of oxygen can be pre-programmed according to a schedule or triggered by a preset oxygen concentration in the container.

The oxygen in the atmosphere of the container may also be removed in step (1) and/or step (2) by other processes, such as chemical catalytic processes. A device to remove oxygen, such as a fuel cell or oxygen absorber, is referred to as “oxygen remover.” Examples of oxygen absorbers include iron containing absorbers and oxygen absorbers, which are known in the art and are commercially available. Oxygen removers also include removers utilizing pressure swing adsorption methods (PSA) and membrane separation methods.

Catalytic systems, such as those utilizing elemental metal such as platinum or palladium catalysts, can be used as oxygen removers but the use of powders necessary to provide high catalytic surface area runs the risk of contamination. Nevertheless, when appropriate safeguards are used, these can be employed. Such safeguards include embedding the metal catalysts into a membrane electrode assembly such as present in PEM fuel cells.

In some embodiments, the air inside the container is pumped to the oxygen remover, such as a fuel cell, by a pump that is in gaseous communication to both the container and the oxygen remover.

### Systems

In another aspect, provided herein is a system useful in transporting and/or storing of a foodstuff comprising an oxygen-dependent or oxygen-labile pigment which method comprises one or more sealable containers comprising the foodstuff.

In some embodiments, the system further comprises one or more fuel cells. The containers are in gaseous communication with one or more of fuel cells internal or external to the containers. One fuel cell may be in gaseous communication with one or multiple containers. Multiple containers may share one or more fuel cells external to the containers. The system optionally further comprises one or more hydrogen sources for operation of the fuel cells to remove oxygen. In some embodiments, the system further comprises a fan. In some embodiments, the fan is powered by the fuel cell. In some embodiments, the fan is powered by another power source.

In some embodiments, the system further comprises an inert gas source for providing the inert gas to replace the oxygen in the container in step (1) of the methods provided herein. In some embodiments, the inert gas comprises argon, helium, and/or nitrogen, and comprises no more than 1%, or no more than 0.1% of carbon dioxide. In some embodiments, the inert gas comprises no carbon dioxide.

The system optionally further comprises a carbon dioxide source (including a gas source providing a low oxygen gas as described which comprises an inert gas and carbon dioxide, such as a gas comprising at least 60% carbon dioxide and remainder is an inert gas, such as nitrogen) for providing carbon dioxide to replace at least a portion of the atmosphere in the container in step (2) of the methods provided herein.

In some embodiments, the container may contain at least one inlet controlled by a valve. During step (1) of the methods provided herein, the inlet may be connected to a source of an inert gas and allows the inert gas to enter into the container to replace at least a portion of the atmosphere of the container that contains oxygen. During step (2) of the methods provided herein, the inlet is connected to a carbon dioxide source and allows carbon dioxide to enter into the container to replace at least a portion of atmosphere of the container containing a reduced concentration of oxygen. The inert gas source and the carbon dioxide source can be any gas source that can provide to the inlet the inert gas or carbon dioxide, respectively, such as a gas cylinder or bladder containing the gas. The inlet is closed when the carbon dioxide concentration in the container is sufficient to preserve the foodstuff contained in the container for a desired amount of time so as to maintain the atmosphere of the sealed container. The inlet used in step (1) and step (2) may be the same or different.

The container may further comprise at least one outlet controlled by a valve which allows the gas inside the container to escape when the inert gas or carbon dioxide is introduced to the container in step (1) or step (2), respectively. In some embodiments, the outlet is connected to one or more fuel cells and then to one or more of the inlets. In these embodiments, the gas inside the container flushed out by the inert gas is passed through the one or more fuel cells to remove the oxygen from the gas. The gas with oxygen removed can be an inert gas source and is then reintroduced to the container through the inlet that is connected to the one or more fuel cells. Other oxygen removers can be used to replace the fuel cell.

Certain configurations of the container/system are illustrated in FIGS. 1-6.

In FIG. 1, container 1 containing a foodstuff 2 comprising an oxygen-dependent or oxygen-labile pigment is connected to an external oxygen remover 6 via outlet 4 and inlet 5. Gas inside the container is released through outlet 4 and treated with oxygen remover 6 which removes oxygen from the gas. The resulting gas with reduced oxygen concentration is reintroduced into container 1 through inlet 5.

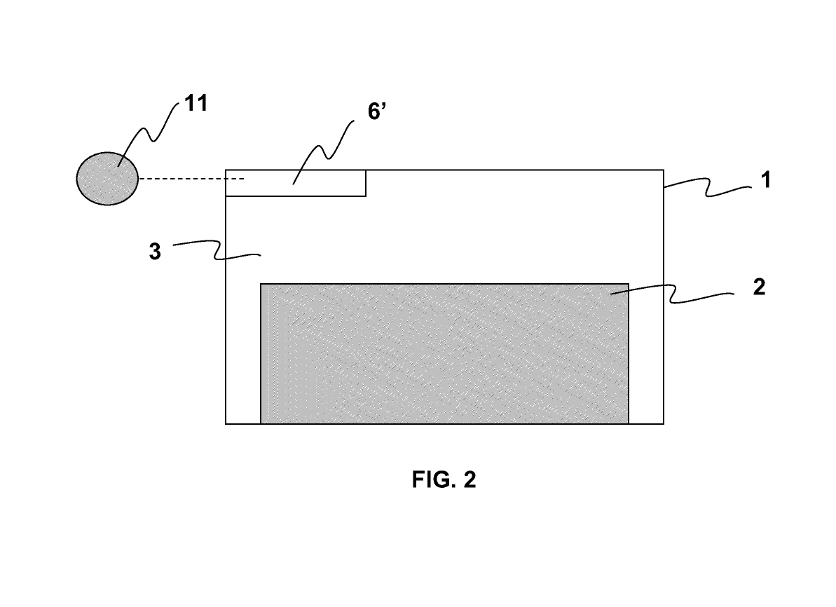

In FIG. 2, container 1 comprises an internal oxygen remover 6′ which removes oxygen from the atmosphere 3 of the container. When oxygen remover 6′ is a hydrogen fuel cell, the hydrogen source 11 can be either internal or external to the container.

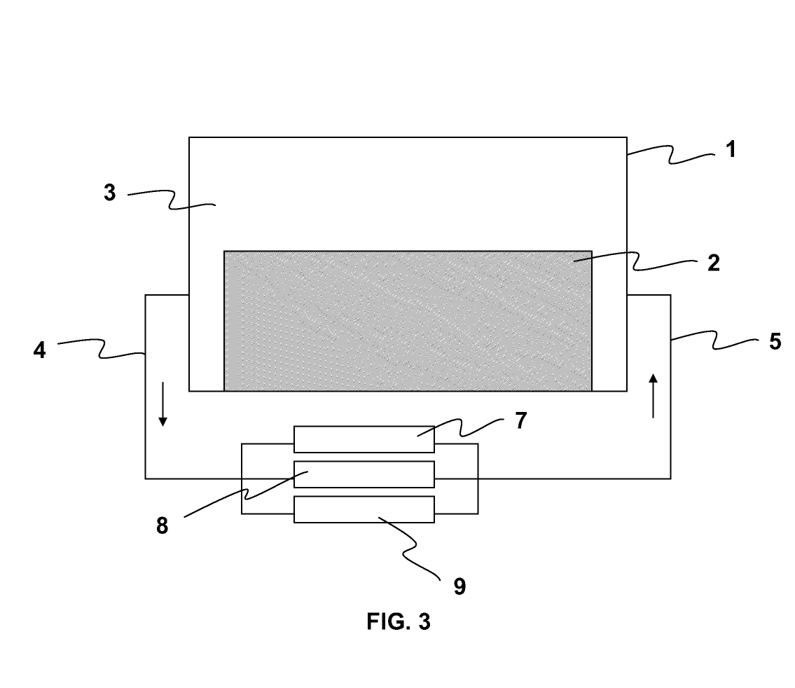

In FIG. 3, container 1 containing foodstuff 2 comprising an oxygen-dependent or oxygen-labile pigment is connected to more than one external oxygen removers 7, 8 and 9. The oxygen removers are in a parallel configuration, each treating a portion of the gas released from outlet 4 to remove the oxygen. The resulting gas is combined and reintroduced into container 1 through inlet 5.

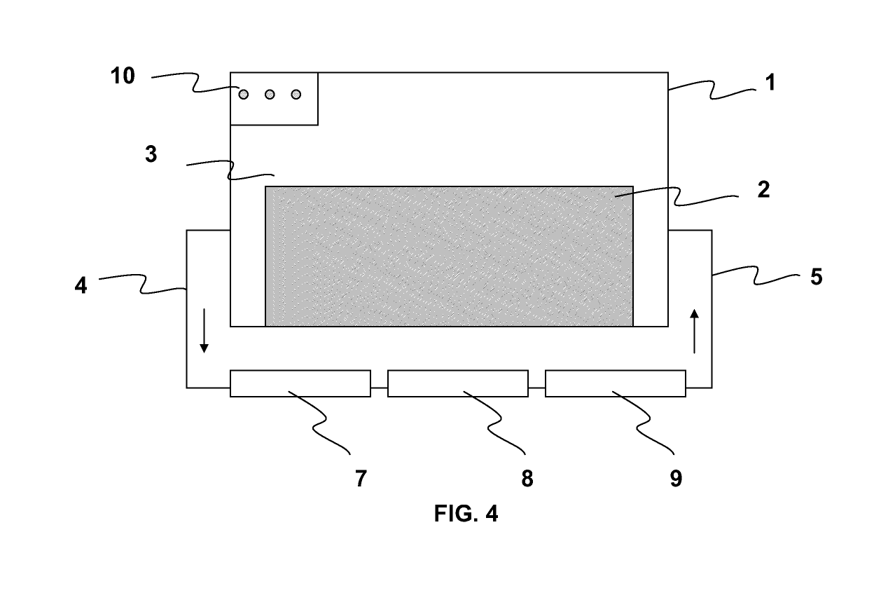

In FIG. 4, container 1 containing foodstuff 2 comprising an oxygen-dependent or oxygen-labile pigment is connected to more than one external oxygen removers 7, 8 and 9. The oxygen removers are in a sequential configuration, so that oxygen remover 7 removes a portion of the oxygen, oxygen removers 8 further removes additional oxygen, and so forth. After treatment with the last oxygen remover in the series, the resulting gas is reintroduced into container 1 through inlet 5.

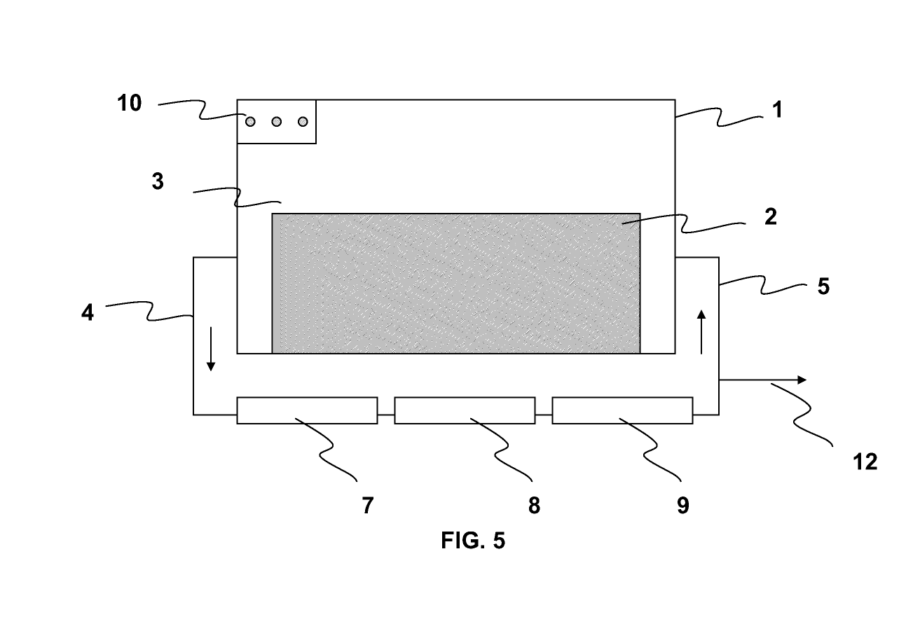

In FIG. 5, container 1 containing foodstuff 2 comprising an oxygen-dependent or oxygen-labile pigment is connected to external oxygen removers which remove oxygen from the atmosphere 3 of container 1. After the gas is treated with the oxygen removers, at least a portion of the gas is released though opening 12.

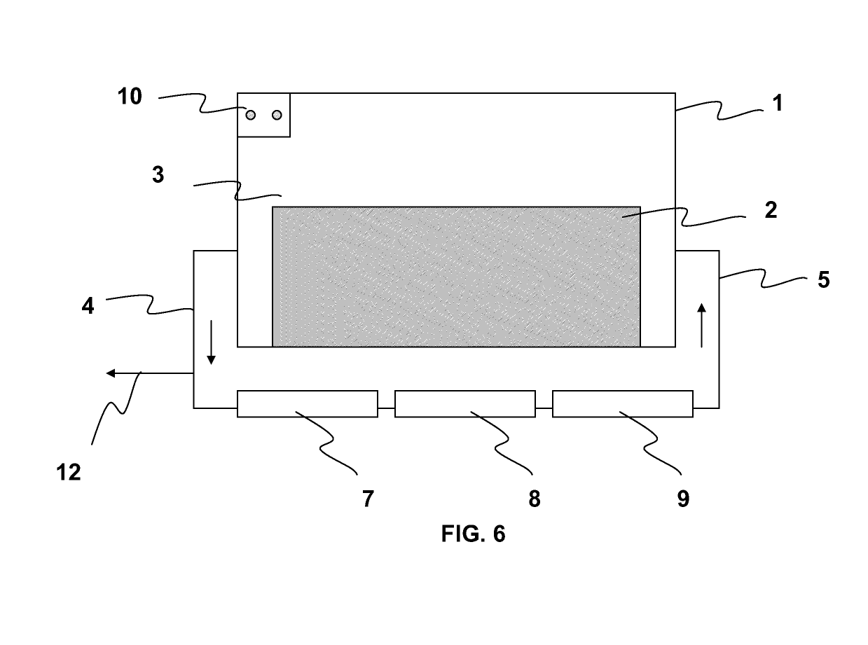

In FIG. 6, container 1 containing foodstuff 2 comprising an oxygen dependent or oxygen-labile pigment is connected to external oxygen removers which remove oxygen from the atmosphere 3 of container 1. Before the gas is treated with the oxygen removers, at least a portion of the gas is released though opening 12.

Fuel cells useful herein are known in the art. In some embodiments, the fuel cell is a hydrogen fuel cell. As used herein, a “hydrogen fuel cell” is any device capable of converting oxygen and hydrogen into water. In a preferred embodiment, the complete fuel cell is internal to the tote. This can be achieved by having a hydrogen source internal or external to the container. The anode of the fuel cell is in communication with the hydrogen source. This hydrogen source permits generation of protons and electrons. The cathode of the fuel cell is in communication with the environment in the container (the oxygen source). In the presence of oxygen, the protons and electrons generated by the anode interact with the oxygen present at the cathode to generate water.

In some embodiments, the hydrogen source for the fuel cell is either a bladder hydrogen source, a rigid container hydrogen source, or a gaseous mixture comprising carbon dioxide and less than 5% by volume hydrogen. In another embodiment, the hydrogen source is contained within a rigid container, such as a gas cylinder. In this embodiment, the hydrogen source is a compressed or uncompressed hydrogen source. In some embodiments, the hydrogen source is uncompressed, which, for example, has a pressure of not greater than 40 psia. Compressed hydrogen sources are preferably maintained at a pressure of no greater than 10,000 psia. The hydrogen source is in direct communication with the anode of the hydrogen fuel cell in such a manner as to provide hydrogen for the duration of the transporting or storage time.

In further embodiments, the hydrogen source is generated by a chemical reaction. Examples of methods of chemically generating hydrogen are well known in the art and include generation of hydrogen by an electrolytic process, including methods using PEM electrolyzers, alkaline electrolyzers using sodium or potassium hydroxide, solid oxide electrolyzers, and generation of hydrogen from sodium borohydride. In each case, the hydrogen is generated so that the hydrogen is made available to the anode of the fuel cell.

In another embodiment, the hydrogen source is a gaseous mixture comprising hydrogen present in the environment of the container. In this embodiment, the gaseous mixture preferably comprises carbon dioxide and hydrogen. In other embodiments, the gaseous mixture comprises nitrogen and hydrogen. In further embodiments, the gaseous mixture comprises hydrogen, carbon dioxide, and nitrogen. It is contemplated that other inert gases can be present in the gaseous mixture. In some embodiments, the amount of hydrogen present in the gaseous mixture is less than 10% hydrogen by volume, less than 5% hydrogen by volume, or less than 2% hydrogen by volume.

In some embodiments, the fuel cell comprises a carbon dioxide remover in direct communication with the sealed anode component of the fuel cell. Carbon dioxide has the potential to permeate across the PEM to anode plate, thereby interfering with hydrogen access to the anode plate. Removal of some or all of the carbon dioxide from the anode plate of the fuel cell by the carbon dioxide remover allows increased access to the fuel cell by hydrogen and thus increasing the fuel cells ability to remove oxygen from the container environment.

There are numerous processes known in the art that can be utilized in the carbon dioxide remover. These methods include absorption processes, adsorption processes, such as pressure-swing adsorption (PSA) and thermal swing adsorption (TSA) methods, and membrane-based carbon dioxide removal. Compounds that can be used in the carbon dioxide removers include, but are not limited to, hydrated lime, activated carbon, lithium hydroxide, and metal oxides such as silver oxide, magnesium oxide, and zinc oxide. Carbon dioxide can also be removed from the anode by purging the anode with a gas, such as hydrogen gas or water vapor.

In one embodiment, the carbon dioxide remover comprises hydrated lime. In this embodiment, for example, the hydrated lime is contained in a filter cartridge that is in vapor communication with the fuel cell anode so that the carbon dioxide present at anode plate of the fuel cell comes into contact and with and is absorbed to the hydrated lime. A particular embodiment comprises two hydrated lime filter cartridges, each in vapor communication with an anode outlet. The hydrated lime filters facilitate removal of carbon dioxide from the anode plate of the fuel cell.

The container or the system optionally further comprises a holding element suitable for maintaining the hydrogen source so as the hydrogen source is held stably within the container or the system. In one embodiment, the holding element is a box configured to stably hold the hydrogen source, and optionally the fuel cell. In other embodiments, the holding element is a sleeve affixed to an internal wall of the container. This sleeve is capable of holding a bladder-containing hydrogen source or rigid container hydrogen source as well as other containers suitable for containing a hydrogen source. In either event, the hydrogen source is in direct communication with the anode of the fuel cell.

Water generated by a hydrogen fuel cell may be released into the container, for example, to a water-holding apparatus, such as a tray or tank, configured to collect the water as it is generated by the fuel cell. Alternatively, the container may contain desiccant or absorbent material that is used to absorb and contain the water. Suitable desiccants and absorbent materials are well known in the art. The water may alternatively be vented outside of the container, thus providing a suitable environment for the storage and transportation of goods that are optimally stored in dry environments.

In some embodiments the container further comprises a fan. In some embodiments, the fan is powered by the fuel cell. In some embodiments, the fan is powered by another power source.

The system may also contain other oxygen removers.

In some embodiments, the container is a rigid room or container described herein.

In some embodiments, the container is a tote described herein.

In some embodiments, the system further comprises a pump between the container and the oxygen remover, such as a fuel cell, for pumping the air inside the container to the oxygen remover.

The flexible, collapsible or expandable tote materials for use in this invention are those having limited oxygen permeability. Materials of limited oxygen permeability preferably have an oxygen transmission rate (OTR) of less than 10 cubic centimeters/100 square inch/24 hours/atm, more preferable materials of limited oxygen permeability are materials having an OTR of less than 5 cubic centimeters/100 square inch/24 hours/atm, even more preferably materials of limited oxygen permeability materials having an OTR of less than 2 cubic centimeters/100 square inch/24 hours/atm; most preferably materials of limited oxygen permeability are materials having an OTR of less than 1 cubic centimeters/100 square inch/24 hours/atm. A non-exhaustive list of materials that can be used to make the flexible, collapsible or expandable tote is shown in Table 1.

TABLE 1

| | Moisture Vapor | Oxygen |
|---|---|---|
| | Transmission | Transmission |
| MATERIAL | Rate (MVTR) | Rate OTR |
| | (gm/100 sq. in./ | (c.c./100 sq. in./ |
| | 24 hours) | 24 hours/atm) |
| Saran 1 mil | 0.2 | 0.8-1.1 |
| Saran HB 1 mil | 0.05 | 0.08 |
| Saranex 142 mil | 0.2 | 0.5 |
| Aclar 33C .75 mil (military | 0.035 | 7 |
| grade) | | |
| Barex 210 1 mil | 4.5 | 0.7 |
| Polyester 48 Ga. | 2.8 | 9 |
| 50 M-30 Polyester Film | 2.8 | 9 |
| 50 M-30 PVDC Coated | 0.4 | 0.5 |
| Polyester | | |
| Metallized Polyester 48 Ga. | 0.05 | 0.08-0.14 |
| Nylon 1 mil | 19-20 | 2.6 |
| Metallized Nylon 48 Ga. | 0.2 | 0.05 |
| PVDC-Nylon 1 mil | 0.2 | 0.5 |
| 250 K Cello | 0.5 | 0.5 |
| 195 MSBO Cello | 45-65 | 1-2 |
| LDPE 2 mil | 0.6 | 275 |
| Opp .9 mil | 0.45 | 80 |
| EVAL, Biax 60 Ga. | 2.6 | 0.03 |
| EVAL EF-E 1 mil | 1.4 | 0.21 |
| EVAL EF-F 1 mil | 3.8 | 0.025 |
| Benyl H 60 Ga | 0.7 | 0.4 |
| PVC 1 mil | 4-5 | 8-20 |
| Polycarbonate 1 mil | 9 | 160 |
| Polystyrene 1 mil | 7.2 | 4,800 |
| Pliofilm 1 mil | 1.7 | 660 |

The container and/or the system may further comprise a temperature control system, such as cooling system, for maintaining a temperature of the container sufficient to preserve the color of the pigment and freshness of the foodstuff. Such temperatures would depend on the nature of the pigment and/or the foodstuff, and can be determined by one of skill in the art. The temperature is generally maintained in a range of about 32-38° F., a range of 32-35° F., or a range of 32-33° F. or 28-32° F. Variation in the temperature is allowed as long as the temperature is maintained within a range to preserve the foodstuff and the color of the pigment.

In some embodiments, the system is a unitized packaging system and the container comprises one or multiple unitized packaging elements described in U.S. patent application Ser. No. 13/______ entitled “Packages and methods for storing and transporting perishable foods” (Attorney Docket 072801-1350), filed on even date, the content of which is incorporated by reference in its entirety.

The container optionally contains monitors to monitor and/or record oxygen levels, hydrogen levels, fuel cell operation, and temperature, etc. In a particular embodiment, an oxygen sensor, for example, a trace oxygen sensor (Teledyne), is used to monitor the level of oxygen present in the tote environment. The oxygen monitor may trigger operation of the oxygen remover and/or provide an alert when the oxygen level in the container exceeds a predetermined level. Optionally, the container further comprises a box comprising one or more of these monitors. The box further optionally comprises a visible indicator, such as an LED light, which indicates problems of the devices in the box so that the problematic device or the box can be immediately replaced before sealing the tote. This facilitates rapid detection of any failure by unskilled labor and allows for rapid turn-around of boxes into service with minimal testing. The box also alerts users on arrival of system if oxygen or temperature (time and temperature) limits are exceeded, for example, using wireless communication, such as radio frequency transmission, along with a visible indicator, such as a red LED light.

It is contemplated that it may be desirable to limit the exposure of the foodstuff to excess hydrogen during transportation or storage. Accordingly, in some embodiments, the container or system is configured to minimize the exposure of the foodstuff to hydrogen present in the environment. This can be achieved by removing the excess hydrogen in the container or system by mechanical methods, such as shut off valves or flow restrictors to modulate, chemical methods, or combinations thereof. Examples of chemical methods of removing hydrogen include the use of a hydrogen sink comprised of polymers or other compounds that absorb hydrogen. Compounds suitable for use as hydrogen absorbers are known in the art and are commercially available (“Hydrogen Getters” Sandia National Laboratories, New Mexico; REB Research & Consulting, Ferndale, Mich.) The compounds can be present in the container or can be in direct communication with the cathode of the fuel cell. Flow of hydrogen can be controlled by using an oxygen sensor connected to the hydrogen source such that hydrogen flow is minimized or eliminated when the level of oxygen falls below a minimum set point.

The system or containers are configured so as to be suitable for transporting and/or storing in a shipping freighter. A shipping freighter means any vehicle that can be used to transport and/or store the system including, but not limited to, an ocean shipping freighter, a trucking shipping freighter (such as a tractor-trailer), a railroad car, and an airplane capable of transporting cargo load. One or more containers can be used in a single shipping freighter and each can be configured to have a different gaseous environment as well as a different foodstuff. The containers can be delivered to the same or different site(s). The size of each container can be different. The containers may hold as little as a few ounces of foodstuff to as much as, or greater than, 50,000 pounds, or tons of foodstuff. In some embodiments, the container can hold about 500 pounds, about 1000 pounds, or about 2000 pounds of foodstuff. The number of packaging modules per system depends both on the size of the shipping freighter used to transport and/or store the foodstuff and the size of the containers.

In another aspect, provided herein is a stabilized foodstuff comprising an oxygen-dependent pigment, wherein said foodstuff is maintained in a sealed container comprising an atmosphere comprising carbon dioxide and no more than about 1% oxygen. In some embodiments, the atmosphere comprises no more than about 1500 ppm oxygen. In some embodiments, the atmosphere is an atmosphere obtained after step (2) of the methods described herein. In some embodiments, the foodstuff has a fresh appearance when exposed to ambient atmosphere. In some embodiments, the oxygen-dependent pigment is myoglobin. In some embodiments, the foodstuff is maintained for a period described herein. In some embodiments, the foodstuff is a foodstuff described herein. In some embodiments, the foodstuff is red meat. In some embodiments, the foodstuff is tilapia, tuna, or mackerel.

### Example

The following description sets forth a specific embodiment of the invention disclosed herein. The specific embodiment is but one of the possible configurations and uses of the present invention and should not be construed in any manner as a limitation of the invention.

Tilapia fillets were stored in the following example. Tilapia fillets contain “blood lines” with a bright red color due to the presence of myoglobin pigment. If upon storage, the myoglobin becomes irreversibly discolored, the blood lines of the tilapia fillets would lose the bright red color and the fish would not appear fresh.

To each of the two containers, Container 1 and Container 2, was placed about 1 metric ton of fresh chilled tilapia fillets packaged in 60 boxes per container (and average of 112 fillets per box) at about 32° F. (0° C.) in Canas, Costa Rica. Container 2 was initially flushed with nitrogen with simultaneous fuel cell operation to remove oxygen. Container 1 was initially flushed with carbon dioxide with simultaneous fuel cell operation to remove oxygen. The oxygen concentration in both containers reached below 0.5% at the end of the initial flush. The containers were kept for 11 to 12 hours at which time the oxygen concentration rose to just under about 1% in both containers. Both containers were then flushed with carbon dioxide until the oxygen concentration was below 0.1%. The containers were held for 30 days. At the end of the day period, the containers were opened and the tilapia fillets inside the containers were observed for freshness. The tilapia fillets in Container 2 had bright red blood lines and were indistinguishable in all aspects from tilapia fillets that were just prepared. The blood lines of the tilapia fillets in Container 1 became a brown color which made the fish look unfresh.

What is claimed is:

1. A method to stabilize an oxygen-dependent or oxygen-labile pigment from discoloration for a predictable period of time in a sealed container, which method comprises
(1) reducing the oxygen concentration in the atmosphere of the container without introducing exogenous carbon dioxide wherein the oxygen concentration is reduced to a level such that pigment damage is minimized over the period of time when exogenous carbon dioxide is introduced into the container, and
(2) introducing exogenous carbon dioxide into the container while retaining or further reducing the oxygen concentration in the atmosphere of the container.

2. The method of claim 1, wherein the pigment is myoglobin.

3. The method of claim 1, wherein the oxygen concentration of step (2) is maintained in the sealed container at least three days.

4. The method of claim 1, wherein the oxygen concentration is reduced by a fuel cell.

5. The method of claim 4, wherein the fuel cell is internal to the container.

6. The method of claim 4, wherein the fuel cell is external to the container.

7. The method of claim 1, wherein the oxygen concentration is reduced by replacing the oxygen with an inert gas.

8. The method of claim 7, wherein the inert gas is nitrogen.

9. The method of claim 1, wherein in step (1), the oxygen concentration in the atmosphere of the sealed container is reduced to less than 5%.

10. The method of claim 1, wherein before step (2), the foodstuff is incubated in the atmosphere produced in step (1) so as to reach deoxygenation of the foodstuff.

11. The method of claim 1, wherein before step (2), the foodstuff is incubated in the atmosphere of the container produced in step (1) for at least 1 hour.

12. The method of claim 1, wherein in step (2), the oxygen concentration in the atmosphere of the sealed container is further reduced to less than 1500 ppm.

13. The method of claim 1, wherein the sealed container is a tote comprising a flexible, collapsible or expandable material.

14. The method of claim 13, wherein the tote comprises a headspace.

15. The method of claim 1, wherein the sealed container is rigid container.

16. The method of claim 1, wherein the pigment is myoglobin pigment present in red meat.

17. The method of claim 1, wherein the pigment is myoglobin pigment present in tilapia, tuna, or mackerel.

18. The method of claim 1, wherein the predictable period of time is at least 3 days.

19. A method to stabilize myoglobin pigment of a foodstuff containing myoglobin pigment during transportation and/or storage of the foodstuff in a sealed container to maintain the freshness and prevent discoloration of the foodstuff, which method comprises
(1) replacing at least a portion of the atmosphere in the container with a nitrogen flush so as to reduce the oxygen concentration to less than 5%, and incubate the foodstuff in the container for a period sufficient to deoxygenate the foodstuff, and
(2) replacing at least a portion of the atmosphere of the container with a sufficient amount of exogenous carbon dioxide to prevent spoilage and account for any absorption of carbon dioxide by the foodstuff thereby maintaining the freshness, and preventing discoloration of the foodstuff upon return to ambient air after a period of at least 3 days in the atmosphere of the sealed container.

20. The method of claim 19, wherein in step (1), the oxygen concentration in the atmosphere of the sealed container is reduced to less than 1%.

21. The method of claim 19, wherein in step (1), the foodstuff is incubated for at least 5 hours.

22. The method of claim 19, wherein in step (2), the oxygen concentration in the atmosphere of the sealed container is further reduced to less than 1500 ppm.

23. The method of claim 19, wherein the sealed container is a tote comprising a flexible, collapsible or expandable material.

24. The method of claim 23, wherein the tote comprises a headspace.

25. The method of claim 19, wherein the foodstuff is red meat.

26. The method of claim 19, wherein the foodstuff is tilapia, tuna, or mackerel.

27. A stabilized foodstuff comprising an oxygen-dependent pigment, wherein said foodstuff is maintained in a sealed container comprising an atmosphere comprising carbon dioxide and no more than about 1% oxygen.

28. The foodstuff of claim 27, wherein the atmosphere comprises no more than about 1500 ppm oxygen.

29. The foodstuff of claim 27, wherein said foodstuff has a fresh appearance when exposed to ambient atmosphere.

30. The method of claim 27, wherein the oxygen-dependent pigment is myoglobin.

31. The method of claim 27, wherein the foodstuff is red meat.

32. The method of claim 27, wherein the foodstuff is tilapia, tuna, or mackerel.
